(19) United States
(12) Patent Application Publication
(10) Pub. No.: US 2024/0375983 A1
(43) Pub. Date: Nov. 14, 2024

(54) SCALE INHIBITOR METHODS AND COMPOSITIONS IN SEVERE OPERATING CONDITIONS

(71) Applicant: CHAMPIONX LLC, Sugar Land, TX (US)

(72) Inventors: Wei Lu, Houston, TX (US); Gedeng Ruan, Houston, TX (US); Narayan Bhandari, Katy, TX (US)

(21) Appl. No.: 18/579,090

(22) PCT Filed: Jul. 15, 2022
(86) PCT No.: PCT/US2022/037359

§ 371 Date: Jan. 12, 2024

Related U.S. Application Data
(60) Provisional application No. 63/222,124, filed on Jul. 15, 2021.

(51) Int. Cl. C02F 5/14

(52) U.S. Cl. CPC C02F 5/14

(57) ABSTRACT

Disclosed herein are compositions comprising a backbone having poly (maleic acid-co-sodium allyl sulfonate), and an additional monomer comprising an anionic monomer, a non-ionic monomer, or a cationic monomer. Further, the unsaturated carboxylic acid of the poly (maleic acid-co-sodium allyl sulfonate) may be present in about 50 weight % or less of the backbone. Compositions herein may comprise an unsaturated carboxylic acid present in the composition in about 50 weight % or less, an unsaturated sulfonic compound or sulfonic acid-based monomer, and an additional monomer bonded to the unsaturated carboxylic acid, the unsaturated sulfonic compound, or sulfonic acid-based monomer, wherein the additional monomer comprises an anionic monomer, a non-ionic monomer, or a cationic monomer.

### CROSS REFERENCE TO RELATED APPLICATIONS

This application claims priority to U.S. Provisional Patent Application Ser. No. 63/222,124 filed on Jul. 15, 2021, the disclosure of which is incorporated herein by reference in its entirety.

### FIELD

The present disclosure relates generally to compositions in aqueous mixtures for use as scale control agents or scale inhibitors. More particularly, compositions disclosed herein may control or inhibit scale formation in produced water systems in high temperature environments, having high calcium content or total dissolved solids (TDS) levels, for example.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Produced water may be produced as a byproduct during oil and gas production Produced water is often characterized as having relatively high total dissolved solids, such as at least about 1 wt % total dissolved solids and as much as about 35 wt % total dissolved solids, in addition to any residual fracturing fluid chemicals flowing back from the injection thereof.

Scale deposition can be limited by using a scale inhibiting agent in a given system in contact with aqueous media, such as produced water. Typically, such scale inhibiting agents include phosphorus containing components, such as phosphates or phosphonates. Such phosphorus containing components may not be desirable if the water is going to be discharged from the system, because phosphorus containing components may foul water sources and surfaces that come in contact with same, often causing unwanted or harmful blooms of algae or other plant life.

Coastal or isolated areas may not have a ready supply of water having low total dissolved solids (TDS), such as less than about 4000 ppm, for circulation through some water containing systems. Even freshwater may be recirculated through a water containing system only a limited number of times before the TDS content therein concentrates to a point where scale deposition takes place. However, replacement freshwater may not be a readily available resource. As long as water having low TDS level is in relatively short supply, users of systems requiring water, such as desalination, cooling, pulp processing, ware-washing, laundry, etc., will continue to search for means of efficiently using the water sources on hand, such as high TDS (e.g., over 4,000 ppm) water sources.

For at least the foregoing reasons, there is a need in the industry for efficient methods and compositions for reducing or preventing the formation of deposits on surfaces in contact with aqueous media, such as by controlling or inhibiting formation of scale or scale-forming compounds. There is further need for polymer compositions suitable for use as scale inhibitors in aqueous systems, such as compositions compatible with produced water having relatively high calcium (e.g., at least 10,000 ppm), TDS levels (e.g., at least 200k ppm), and/or at high temperatures (e.g., at least 100° C.).

### SUMMARY

Among the aspect of the disclosure is a deposit inhibitor composition comprising an unsaturated carboxylic acid present in the composition in about 50 weight % or less; an unsaturated sulfonic compound or sulfonic acid-based monomer; and an additional monomer bonded to the unsaturated carboxylic acid, the unsaturated sulfonic compound, or sulfonic acid-based monomer, wherein the additional monomer comprises an anionic monomer, a non-ionic monomer, or a cationic monomer.

Another aspect is a polymer composition comprising a backbone comprising poly (maleic acid-co-sodium allyl sulfonate); and an additional monomer comprising an anionic monomer, a non-ionic monomer, or a cationic monomer, wherein an unsaturated carboxylic acid of the poly (maleic acid-co-sodium allyl sulfonate) is present in less than 50 weight % of the backbone.

Yet another aspect is a method of inhibiting deposit formation in produced water from a subterranean formation, the method comprising providing a composition comprising an unsaturated carboxylic acid present in the composition in about 60 weight % or less; and an unsaturated sulfonic compound or sulfonic acid-based monomer bonded to an additional monomer comprising an anionic monomer, a non-ionic monomer, or a cationic monomer.

Other objects and features will be in part apparent and in part pointed out hereinafter.

### DESCRIPTION OF THE DRAWINGS

FIG. 1 is a graph of the differential pressure (DP) versus time measured in a 130° C. Dynamic Scale Loop (DSL) system using various Scale Inhibitors (Sis) at 800 ppm dosage.

FIG. 2 is a graph of the DP versus time measured in a 130° C. DSL using ZP-SI-3 at 800 ppm dosage and 800 ppm ZP-SI-3 with 126 ppm choline chloride as stabilizer.

FIG. 3 is a graph of the DP versus time measured in a 130° C. DSL using 1:1 blends of various polymeric SIs and polyaminomethylenephosphonate (PAPEMP). The SI blend dosage is 800 ppm from 0 to 60 min and 600 ppm from 60 to 120 min.

### DETAILED DESCRIPTION

Although the present disclosure provides references to preferred embodiments, persons skilled in the art will recognize that changes may be made in form and detail without departing from the spirit and scope of the disclosure. Additionally, any examples set forth in this specification are not intended to be limiting and merely set forth some of the many possible embodiments for the appended claims.

Various specific embodiments and versions of the present disclosure will now be described, including preferred embodiments and definitions that are adopted herein. While the following detailed description gives specific preferred embodiments, those skilled in the art will appreciate that these embodiments are exemplary only, and that the present disclosure can be practiced in other ways.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of’ and “consisting essentially of,” the embodiments or elements presented herein, whether explicitly set forth or not.

Certain embodiments and features have been described using a set of numerical upper limits and a set of numerical lower limits. It should be appreciated that ranges from any lower limit to any upper limit are contemplated unless otherwise indicated. All numerical values are “about” or “approximately” the indicated value, and take into account experimental error and variations that would be expected by a person having ordinary skill in the art.

As used herein, a “polymer” may refer to homopolymers, copolymers, interpolymers, terpolymers, or the like. As used herein, when a polymer is referred to as comprising a monomer, the monomer may be present in the polymer in the polymerized form of the monomer or in the derivative form of the monomer. Further, as used herein, the term “copolymer” is meant to include polymers having two or more monomers, optionally with other monomers, and may refer to interpolymers, terpolymers, and the like.

As used herein, “deposit” may refer to any material that may develop and/or build up during an oil and gas operation. A deposit may include mineral, salt, scale, corrosion, and the like.

As used herein, “scale” may refer to any scale forming in an aqueous solution or any deposit that may reduce flow assurance. Examples of scale may include calcium carbonate, calcium sulfate, calcium phosphate, calcium phosphonate (including calcium hydroxyethylidene diphosphonic acid), calcium oxalate, barium sulfate, iron sulfide, silica, alluvial deposits, metal oxide (including iron oxide), metal hydroxide (including magnesium hydroxide), barite, celestite, anhydrite, their associated salts, and mixtures thereof.

As used herein, “aqueous system” may include any system containing water, including but not limited to, produced water, cooling water, boiler water, desalination, gas scrubbers, blast furnaces, reverse osmosis, upstream and midstream oil and gas applications, and the like.

The present disclosure relates to compositions such as mineral scale deposit inhibiting compositions, scale inhibiting polymer compositions, scale inhibition blends, and the like. More particularly, compositions disclosed herein may inhibit scale formation in produced water systems in high temperature environments and having high calcium content or total dissolved solids (TDS) levels, for example. Further, compositions herein may be used to inhibit or control formation of common mineral scales during oil and gas production. Exemplary mineral scales include, but are not limited to, calcite, barite, celestite, anhydrite, and the like.

The exemplary details below are not intended to be limiting but instead are provided to show the breadth of compositions and methods disclosed herein.

Compositions herein exhibit improved brine compatibility and scale inhibition performance, stability in varying temperature ranges, and static efficiency as compared to compositions without polymers disclosed herein.

An unsaturated carboxylic acid or salt may be used to prepare polymers here. Examples of possible unsaturated carboxylic acids may include, but are not limited to, acrylic acid, methacrylic acid, α-halo acrylic acid, β-carboxyethylacrylate, maleic acid, itaconic acid, vinyl acetic acid, allyl acetic acid, fumaric acid, β-carboxyethyl acrylate, their associated salts, and mixtures thereof.

An unsaturated sulfonic compound, unsaturated sulfonic acid-based monomer, or associated salt(s) may be used to prepare polymers herein. Examples include 2-acrylamido-2-methylpropylsulfonic acid, 2-methacrylamido-2-methylpropylsulfonic acid, sodium allyl sulfonate (SAS), sodium methallyl sulfonate (SMAS), styrene sulfonic acid, vinyl sulfonic acid, sulfo alkyl acrylate or methacrylate, allyl sulfonic acid, methallyl sulfonic acid, 3-methacrylamido-2-hydroxy propyl sulfonic acid, sulfonic acid acrylate, their associated salts and mixtures thereof.

Compositions herein may further comprise any monomer such as an anionic monomer, a non-ionic monomer, or a cationic monomer. Such additional monomer may comprise a cationic monomer including an unsaturated quaternary ammonium compound, for example. In embodiments, an unsaturated quaternary ammonium compound may include dimethyl diallyl ammonium chloride (DADMAC), diethyldiallyl ammonium chloride (DEDMAC), methacryloyloxyethyl trimethyl ammonium chloride (METAC), methacryloxyloxyethyl trimethyl ammonium methosulfate (METAMS), acryloyloxyethyl trimethyl ammonium chloride (AETAC), methacrylamido propyl trimethyl ammonium chloride (MAPTAC), acryloyloxyethyl trimethyl ammonium methosulfate (AETAM), acrylamido methyl propyl trimethyl ammonium chloride (AMPTAC), acrylamido methyl butyl trimethyl ammonium chloride (AMBTAC), and the like. Compositions may also comprise an anionic monomer, a non-limiting example of which may be sodium 3-allyloxy-2-hydroxy-1-propansulfonate (AHPS). Further, compositions may comprise a non-ionic monomer, a non-limiting examples of which may include allyl alcohol and ethoxylated allyl alcohol (e.g., 9EO-AA).

In embodiments, a non-ionic monomer may be acrylamide, acrylate ester, N-vinylpyrrolidones, or mixtures thereof.

Additional monomers may also be present in polymers herein including, but not limited to, acrylic acid, acrylamide, dialkyldiallyl ammonium monomers, allylamine, diallylamine, methacrylamide, acrylonitrile, vinyl or allyl compounds, vinyl phosphonic acid, and the like.

Compositions herein may further comprise poly (maleic acid-co-sodium allyl sulfonate) as a backbone, foundation monomer or copolymer. Also, anionic polymeric scale inhibitors (AP-SI) and zwitterionic polymeric scale inhibitors (ZP-SI) are disclosed herein.

In embodiments, polymers in the present disclosure may be prepared with unsaturated carboxylic acid from less than 50 wt % of the backbone comprising poly (maleic acid-co-sodium allyl sulfonate). In embodiments, the polymers may comprise 45 wt % to 5 wt %, or 40 wt % to 10 wt %, or 30 wt % to 20 wt %, of an unsaturated carboxylic acid or associated salt as a component of the backbone.

The present disclosure includes development of deposit and/or scale inhibitor blends or compositions, and may demonstrate synergies between and among various compositions. Further, mole ratios of unsaturated carboxylic acid component to unsaturated sulfonic/sulfonic-acid component be from 1:3 to about 3:1 in some embodiments, and 1:2 to about 2:1 in other embodiments. As ratios of unsaturated carboxylic acid component to unsaturated sulfonic/sulfonic-acid component are varied, enhancement of calcium tolerance may be seen. Further, as concentrations of the unsaturated sulfonic/sulfonic-acid component are increased, brine compatibility of compositions herein may be shown to increase, and hence performance is seen to improve.

In some embodiments, increase amounts of anionic monomers such as sodium 3-allyloxy-2-hydroxy-1-propansulfonate (AHPS), for example, may exhibit increased brine compatibility at relatively high temperatures, e.g., from about 90° to 130° C. In other embodiments, enhanced brine compatibility may be seen in compositions having cationic monomers, such as DADMAC, for example.

The polymers may be prepared by mixing monomers in water and polymerizing under various conditions. In embodiments, monomers herein may be polymerized under reflux conditions, and in other embodiments, at room temperature.

In other embodiments, monomers may be mixed in the presence of nitrogen. In further embodiments, monomers may polymerize in the presence of initiators (e.g., ammonium persulfate and sodium metabisulfite). Non-limiting examples of initiators include, but are not limited to, t-butyl hydroperoxide and/or sodium hypophosphite, azo-based initiators, and the like.

Furthermore, polymerization may be conducted by any of a variety of procedures, for example, in solution, suspension, bulk, emulsions, via photopolymerization, and the like.

An effective amount of any polymer herein may be added to an aqueous system being treated. In embodiments, an effective amount of polymer may be in the range of about 0.1 ppm to about 1000 ppm, for example.

Compositions, including polymer compositions, herein may further comprising a stabilizer. In embodiments, the stabilizer may comprise a cationic compound, an anionic compound, or a zwitterionic compound. In an embodiment, a stabilizer may comprise choline chloride.

Methods and compositions disclosed may be used under severe operating conditions in oilfield applications. Examples of possible severe or harsh conditions may include, but are not limited to, systems exhibiting relatively high level of calcium (e.g., at least 10,000 ppm), supersaturation levels of inorganic minerals (e.g., calcite, barite, and celestite), relatively high TDS levels (e.g., at least 200k ppm), and/or at high temperatures (e.g., at least 100° C.). Methods and compositions disclosed may also be used for continuous application for topside and/or downhole including mineral scale control, and/or squeeze applications. As used herein, operating conditions may refer to various oil and gas exploration conditions, including but not limited to, ultra-deep exploration area(s), sweet gas and/or high calcium/carbonate environments, carbonate formations, and/or high productivity wells. Additives and materials herein may further enhance capabilities of compositions for storage, transportation, and applications in various temperature ranges.

### EXAMPLES

### Synthesis of Polymeric Scale Inhibitors (Procedure A)

Monomers, chelating agents (e.g., ethylenediaminetetraacetic acid or EDTA), and water are added into the glass reactor connected with reflux condenser and purged with N₂ for 15 minutes at 300 RPM before heating from about 95° C. to 100° C. The redox initiator solutions of ammonium persulfate and sodium metabisulfite, for example, are injected into the monomer containing solution continuously for 5 hrs. The reaction then continues from about 95° C. to 100° C. for 1 hour before it is adjusted to a desired pH range using 50 wt % NaOH and the temperature is reduced to room temperature.

### Synthesis of Polymeric Scale Inhibitors (Procedure B)

Monomers, chelating agents (e.g., ethylenediaminetetraacetic acid or EDTA), and water are added into the stainless-steel reactor connected with reflux condenser and purged with N₂ for 15 minutes at 300 RPM before heating from about 50° C. to 75° C. 50 wt % of NaOH is added to increase the pH to 1.5. The redox initiator solutions of ammonium persulfate and sodium metabisulfite, for example, are injected into the monomer containing solution continuously for 5 hrs while the temperature is increased to 95° C. to 100° C. The reaction then continues from about 95° C. to 100° C. for 1 hour before it is adjusted to a desired pH range using 50 wt % NaOH and the temperature is reduced to room temperature.

Anionic polymeric scale inhibitors, e.g., AP-SI, are constituted by a copolymer of (1) maleic acid (MA) and sodium allylsulfonate (SAS); (2) maleic acid (MA), sodium allylsulfonate (SAS), and Sodium 3-allyloxy-2-hydroxy-1-propanesulfonate (AHPS); and/or (3) maleic acid (MA), sodium allylsulfonate (SAS), and ethoxylated allyl alcohol (9EO-AA).

Structure 1 and Table 1 (below) show exemplary chemical structure(s) of the sodium salt of MA/SAS copolymer and chemical composition of three MA/SAS copolymers, respectively.

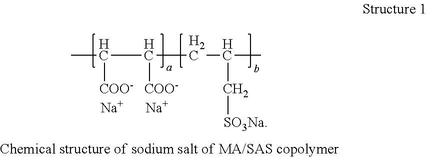

TABLE 1
Chemical composition of MA/SAS copolymer

| SI Name | MA (mol %) | SAS (mol %) |
|---|---|---|
| AP-SI-1 | 50 | 50 |
| AP-SI-2 | 33 | 67 |
| AP-SI-3 | 25 | 75 |

Structure 2 and Table 2 (below) show the chemical structure of the sodium salt of MA/SAS/AHPS copolymer and chemical composition of three MA/SAS/AHPS copolymers, respectively.

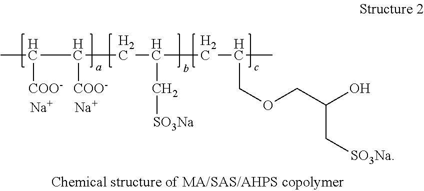

TABLE 2
Chemical composition of MA/SAS/AHPS copolymer

| SI Name | MA (mol %) | SAS (mol %) | AHPS (mol %) |
|---|---|---|---|
| AP-SI-4 | 50 | 30 | 20 |
| AP-SI-5 | 50 | 19 | 31 |
| AP-SI-6 | 50 | 0 | 50 |

Structure 3 and Table 3 (below) show the chemical structure of the sodium salt of MA/SAS/9EO-AA copolymer and chemical composition of MA/SAS/9EO-AA copolymers, respectively.

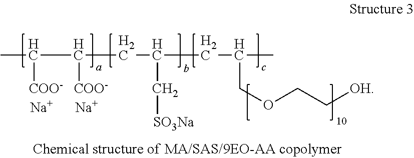

TABLE 3
Chemical composition of MA/SAS/9EO-AA copolymer

| SI Name | MA (mol %) | SAS (mol %) | 9EO-AA (mol %) |
|---|---|---|---|
| AP-SI-7 | 29 | 61 | 10 |

Zwitterionic polymeric scale inhibitors, e.g., ZP-SI, are consisted by a copolymer of (1) maleic acid (MA), sodium allylsulfonate (SAS), and diallyldimethylammonium chloride (DADMAC); (2) MA, SAS, DADMAC, and sodium 3-allyloxy-2-hydroxy-1-propanesulfonate (AHPS).

Structure 4 and Table 4 (below) show the chemical structure of the sodium salt of MA/SAS/DADMAC copolymer and chemical composition of three MA/SAS/DADMAC copolymers, respectively.

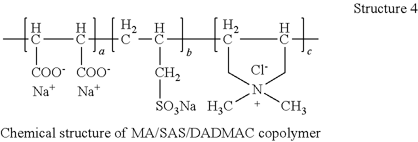

TABLE 4
Chemical composition of MA/SAS/DADMAC copolymer

| SI Name | MA (mol %) | SAS (mol %) | DADMAC (mol %) |
|---|---|---|---|
| ZP-SI-1 | 27 | 67 | 6 |
| ZP-SI-2 | 33 | 57 | 10 |
| ZP-SI-3 | 51 | 30 | 19 |

Structure 5 and Table 5 show the chemical structure of the sodium salt of MA/SAS/AHPS/DADMAC copolymer and chemical composition of three MA/SAS/AHPS/DADMAC copolymers, respectively.

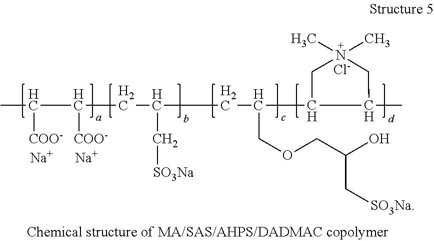

TABLE 5
Chemical composition of MA/SAS/AHPS/DADMAC copolymer

| | | | AHPS | DADMAC |
|---|---|---|---|---|
| SI Name | MA (mol %) | SAS (mol %) | (mol %) | (mol %) |
| ZP-SI-4 | 50 | 25 | 20 | 5 |
| ZP-SI-5 | 50 | 20 | 20 | 10 |
| ZP-SI-6 | 50 | 15 | 20 | 15 |

### Brine Compatibility Test

Table 6 shows the brine composition for the brine compatibility test. The scale inhibitor dosage is 5000 mg/kg and the testing temperature is 90° C. or 130° C. and the duration of the test is 24 h. The brine compatibility of the scale inhibitor is visually determined based on whether there is any precipitate forming, or the solution becomes cloudy.

TABLE 6
Brine composition for brine compatibility test

| Ions | Conc (mg/L) |
|---|---|
| Na⁺ | 67,756 |
| Mg²⁺ | 1,081 |
| Ca²⁺ | 10,067 |
| Sr²⁺ | 3,663 |
| Ba²⁺ | 504 |
| Cl⁻ | 127,371 |

Table 7 lists the brine compatibility of different AP-SIs at 90° C. and 130° C. AP-SI-1 and neutralized sulfonated polycarboxylate copolymer (SPCA) may not be compatible with the compatibility brine at 90° C. and 130° C. One approach to increase its brine compatibility is to increase the SAS mol % in the polymer backbones. As indicated in AP-SI-2 and AP-SI-3, they become compatible with the compatibility brine at 90° C.

The second approach to increase brine compatibility is to incorporate a third monomer into the polymer backbone. The third monomer can be an anionic monomer like AHPS, a non-ionic monomer like 9EO-AA, or a cationic monomer like DADMAC.

As shown in AP-SI-4, by replacing 20% SAS by AHPS, makes it compatible with the brine at 90° C. Further increase of AHPS mol %, as shown in AP-SI-5, AP-SI-6, leads to compatibility with the brine at 130° C.

As shown in AP-SI-7, by replacing 10% of SAS by 9EO-AA, makes it compatible with brine at 90° C. and 130° C.

TABLE 7
Brine compatibility of the AP-SIs at 90° C. and 130° C.

| SI Name | 90° C. | 130° C. |
|---|---|---|
| Neutralized | X | X |
| Sulfonated | | |
| polycarboxylate | | |
| copolymer (SPCA) | | |
| AP-SI-1 | X | X |
| AP-SI-2 | ✓ | X |
| AP-SI-3 | ✓ | X |
| AP-SI-4 | ✓ | X |
| AP-SI-5 | ✓ | ✓ |
| AP-SI-6 | ✓ | ✓ |
| AP-SI-7 | ✓ | ✓ |

Table 8 lists the brine compatibility of different ZP-SIs at 90° C. and 130° C. As shown in ZP-SI-1, ZP-SI-2, ZP-SI-3, the incorporation of DADMAC into the polymeric backbone of poly(maleic acid-co-sodium ally sulfonate) improves the brine compatibility at 90° C. and 130° C. Furthermore, replacing part of SAS by DADMAC in AP-SI-4 also improves its brine compatibility at 130° C.

TABLE 8
Brine compatibility of the ZP-SIs at 90° C. and 130° C.

| SI Name | 90° C. | 130° C. |
|---|---|---|
| ZP-SI-1 | ✓ | ✓ |
| ZP-SI-2 | ✓ | ✓ |
| ZP-SI-3 | ✓ | ✓ |
| ZP-SI-4 | ✓ | ✓ |
| ZP-SI-5 | ✓ | ✓ |
| ZP-SI-6 | ✓ | ✓ |

### 70° C. Static Efficiency Bottle Test

The static efficiency bottle test was used to evaluate the inhibition efficiency of sulfate bearing scales (generally BaSO4 and SrSO4) precipitation. Anion brine and cation brine were prepared according to Table 9. The preheated anion brine and cation brine were mixed at 1 to 1 (v/v) ratio to achieve the targeted concentration. Briefly, in the blank test, no SI was added, but a known amount of various SIs was added to other test bottles to understand the performance of various SIs. In the scale inhibition tests, inhibition performance or inhibition efficiency at 70° C., especially for barite inhibition at one hour after mixing of anion and cation brine with and without presence of scale inhibitors was determined using equation below

At where:

$$Efficiency ( \% ) = \frac{( {C}_{a} - {C}_{b} ) * 100}{( {C}_{0} - {C}_{b} )}$$

Cₐ=concentration (mg/L) of Ba²⁺ in solution after the one-hour test with scale inhibitor,
C_{b}=concentration (mg/L) of Ba²⁺ in solution in the blank after the one-hour test (without scale inhibitor);
C₀=concentration (mg/L) of the resulting Ba²⁺ in synthetic water.

TABLE 9
Brine composition for anion brine and cation
brine of 70° C. static bottle test

| | Cation Brine | Anion Brine |
|---|---|---|
| Salt | g per L | g per L |
| NaCl | 170.10 | 170.09 |
| MgCl₂•6 H₂O | 18.08 | 0 |
| CaCl₂•2 H₂O | 73.85 | 0 |
| SrCl₂•6 H₂O | 22.29 | 0 |
| BaCl₂•2 H₂O | 1.7930 | 0 |
| Na₂SO₄ | 0 | 0.8044 |

Table 10 (below) summarizes the 70° C. static efficiency test results of different AP-SIs at 20 ppm dosage. AP-SI-1, 2, 3, 4, 5 have barite inhibition efficiency of 90-100% for one hour. AP-SI-6 and AP-SI-7 have 60-70% inhibition efficiency.

TABLE 10
70° C. static efficiency test results
of different AP-SIs at 20 ppm dosage

| SI Name | Efficiency (%) |
|---|---|
| SPCA | 100% |
| AP-SI-1 | 100% |
| AP-SI-2 | 100% |
| AP-SI-3 | 92% |
| AP-SI-4 | 100% |
| AP-SI-5 | 94% |
| AP-SI-6 | 67% |
| AP-SI-7 | 60% |

Table 11 summarizes the 70° C. static efficiency test results of different ZP-SIs at 20 ppm dosage. ZP-SI-1, 2, 4, 5 have barite inhibition efficiency of 90-100% in one hour. ZP-SI-3 and ZP-SI-6 have 80-86% inhibition efficiency.

TABLE 11
70° C. static efficiency test results
of different ZP-SIs at 20 ppm dosage

| SI Name | Efficiency (%) |
|---|---|
| ZP-SI-1 | 90% |
| ZP-SI-2 | 100% |
| ZP-SI-3 | 86% |
| ZP-SI-4 | 95% |
| ZP-SI-5 | 96% |
| ZP-SI-6 | 80% |

Table 12 summarizes the 70° C. static efficiency test results of 1:1 (w/w) blend of different SIs and phosphonate component, e.g., polyaminomethylenephosphonate (PAPEMP). In embodiments, PAPEMP may be used in a blend at 20 ppm dosage. In other embodiments, blends comprising approximately 20-60 wt % PAPEMP may be used. As shown in Table 12, the one-hour barite inhibition efficiencies of tested blends are all in the range of 90-100%.

TABLE 12
70° C. static efficiency test results of 1:1
(w/w) blend of different SIs and PAPEMP at 20 ppm dosage

| SI Name | Efficiency (%) |
|---|---|
| AP-SI-2 + PAPEMP | 100% |
| AP-SI-3 + PAPEMP | 90% |
| ZP-SI-1 + PAPEMP | 100% |
| ZP-SI-2 + PAPEMP | 100% |
| ZP-SI-3 + PAPEMP | 100% |
| ZP-SI-4 + PAPEMP | 94% |
| ZP-SI-5 + PAPEMP | 100% |
| ZP-SI-6 + PAPEMP | 99% |

### 130° C. Dynamic Scale Loop Test

The Dynamic Scale Loop (DSL) test was performed to determine minimum effective dose (MED) of the chemical additives or scale inhibitor(s). The test is widely used in the industry as a means to determine the tendency of synthetic or field brine to form scales (such as calcite, barite, celestite, anhydrite, etc.) in a capillary tubing at desired temperature and pressure. The apparatus can also be used to determine the effectiveness of scale inhibiting additives. The DSL holds two sets of fluids (cation brine and anion brine) contained in reservoirs on top of the unit. The cation brine contains the scaling cations (Ca²⁺, Fe²⁺, Ba2⁺, Mg²⁺, etc.) of interest, while the anion brine contains the scaling anions (SO₄²⁻, HCO₃⁻, etc.). The remaining ions of the brines are divided equally between the fluids to give them similar densities. The final mixture of the two fluids results in the synthetic brine of interest. In this test, the total flow rate (5 mL/min of anion brine and 5 mL/min of cation brine) was maintained at 10 mL/min and capillary tubing used was 1 m long that has 0.5 mm internal diameter. The DSL used in this study is a high temperature/high pressure equipment, operating with pressures of up to 4000 psi and temperatures up to 250° C. It is used to rank inhibitors and give an approximate dosage level. As scale builds-up on the interior surface of the small metallic capillary tube of the scale loop, a difference in pressure between the two ends can be measured. Therefore, a rapid pressure increase is indicative of severe scaling conditions. The blank run is typically repeated to obtain the average blank time. The inhibited fluids are then evaluated starting with a high concentration of inhibitor and reducing the concentration until an increase in differential pressure (dp) is observed (>0.5 psi). Each concentration is run for 60 minutes. If the tested concentration does not reach the cut-off pressure within the reference scale time, the next dosage of scale inhibitor is evaluated until scaling is observed. The recommended minimum effective dosage (MED) is the lowest tested concentration that has less than 0.5 psi differential pressure increase. Therefore, the time to reach a dp rise of 0.5 psi is defined as scaling time.

Table 13 lists the brine composition, pH, temperature, and pressure for DSL test.

TABLE 13
Brine composition for DSL test

| Ions | Conc (mg/L) |
|---|---|
| Na⁺ | 67,756 |
| Mg²⁺ | 1,081 |
| Ca²⁺ | 10,067 |
| Sr²⁺ | 3,663 |
| Ba²⁺ | 504 |
| Cl⁻ | 127,371 |
| HCO₃⁻ | 1735 |
| SO₄²⁻ | 272 |
| pH | 6.1 |
| T (° C.) | 130 |
| Pressure (bar) | 10 |

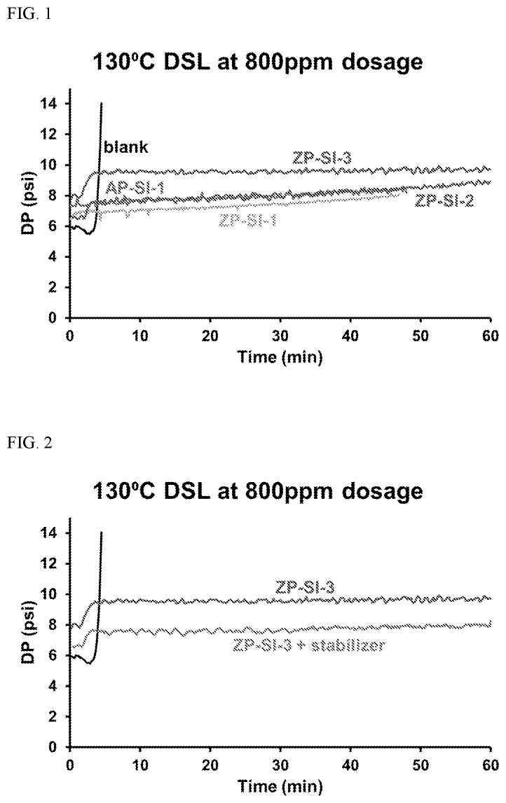

Table 13 summarizes DSL the results of various SIs at 800 ppm dosage and FIG. 1 shows their DSL differential pressure vs time traces. As compared to others, ZP-SI-3 passed the test criteria.

TABLE 14
130° C. DSL test results of different SIs at 800 ppm dosage

| SI Name | Test Outcomes |
|---|---|
| AP-SI-3 | Fail (at 29 mins) |
| ZP-SI-1 | Fail (at 31 mins) |
| ZP-SI-2 | Fail (at 31 mins) |
| ZP-SI-3 | Pass |

In order to improve the room temperature stability of the zwitterionic polymeric scale inhibitors, additives including choline chloride have been used. As shown in FIG. 2, choline chloride does not interfere the inhibition efficiency of ZP-SI-3.

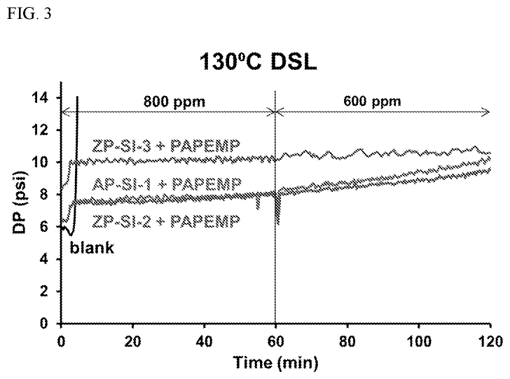

Comparing the polymeric scale inhibitor and its 1:1 blend with PAPEMP in FIG. 2 and FIG. 3, it shows that the blend shows enhanced scale inhibition performance as compared to the polymeric scale inhibitor at the same dosage level. In other words, there is synergy between the polymeric scale inhibitor and PAPEMP when they are used together in the DSL test.

In the previous sections, specific embodiments of the present disclosure are described in connection with disclosed aspects and methods. However, to the extent the description is specific to a particular aspect, technique, or particular use, this is intended to be for exemplary purposes only. Accordingly, the present disclosure is not limited to the disclosed aspects and techniques described above, but rather includes all alternatives, embodiments, modifications, and equivalents falling within the spirit and scope of claims that follow.

While the present disclosure has been described and illustrated by reference to particular embodiments, those of ordinary skill in the art will appreciate that the disclosure leads itself to variations not necessary illustrated herein. For this reason, reference should be made solely to the claims below for purposes of determining the true scope of the invention.

1. A deposit inhibitor composition comprising:
an unsaturated carboxylic acid present in the composition in about 50 weight % or less;
an unsaturated sulfonic compound or sulfonic acid-based monomer; and
an additional monomer bonded to the unsaturated carboxylic acid, the unsaturated sulfonic compound, or sulfonic acid-based monomer,
wherein the additional monomer comprises an anionic monomer, a non-ionic monomer, or a cationic monomer.

2. The composition of claim 1, wherein the unsaturated carboxylic acid is selected from the group consisting of maleic acid, acrylic acid, maleic anhydride, methacrylic acid, associated salts, and mixtures thereof.

3. The composition of claim 2, wherein the unsaturated sulfonic compound or sulfonic acid-based monomer is selected from the group consisting of 2-acrylamido-2-methylpropylsulfonic acid, 2-methacrylamido-2-methypropyl sulfonic acid, sodium allyl sulfonate (SAS), sodium methallyl sulfonate (SMAS), associated salts, and mixtures thereof.

4. The composition of claim 1, comprising an additional monomer selected from the group consisting of an unsaturated quaternary ammonium compound, sodium 3-allyloxy-2-hydroxy-1-propansulfonate (AHPS), ethoxylated allyl alcohol (9EO-AA), vinyl phosphonic acid, an associated salt, and mixture thereof.

5. The composition of claim 4, wherein the unsaturated quaternary ammonium compound comprises an allyldimethylammonium chloride, allyl diethylammonium chloride, associated salts, or mixtures thereof.

6. The composition of claim 1, wherein the non-ionic monomer comprises acrylamide, acrylate ester, N-vinylpyrrolidones, or mixtures thereof.

7. The composition of claim 1 comprising a phosphonate component.

8. The composition of claim 7, wherein the phosphonate component comprises polyaminomethylenephosphonate (PAPEMP).

9. The composition of claim 1 comprising a stabilizer selected from the group consisting of choline chloride, a cationic compound, an anionic compound, a zwitterionic compound, or a combination thereof.

10. The composition of claim 1, wherein the unsaturated carboxylic acid is present in the composition in about 40 weight % or less.

11. A polymer composition comprising:
a backbone comprising poly (maleic acid-co-sodium allyl sulfonate); and
an additional monomer comprising an anionic monomer, a non-ionic monomer, or a cationic monomer,
wherein an unsaturated carboxylic acid of poly (maleic acid-co-sodium allyl sulfonate) is present in less than 50 weight % of the backbone.

12. The composition of claim 11, wherein the unsaturated carboxylic acid is selected from the group consisting of maleic acid, acrylic acid, maleic anhydride, methacrylic acid, associated salts and mixtures thereof.

13. The composition of claim 11, wherein the unsaturated sulfonic or sulfonic acid-based component of poly (maleic acid-co-sodium allyl sulfonate) is selected from the group consisting of 2-acrylamido-2-methylpropylsulfonic acid, 2-methacrylamido-2-methypropyl sulfonic acid, sodium allyl sulfonate (SAS), sodium methallyl sulfonate (SMAS), associated salts, and mixtures thereof.

14. The composition of claim 11, wherein the additional monomer is selected from the group consisting of an unsaturated quaternary ammonium compound, sodium 3-allyloxy-2-hydroxy-1-propansulfonate (AHPS), ethoxylated allyl alcohol (9EO-AA), vinyl phosphonic acid, an associated salt, or mixture thereof.

15. The composition of claim 14, wherein the unsaturated quaternary ammonium compound comprises a polyallyldimethylammonium chloride.

16. The composition of claim 11, wherein the non-ionic monomer comprises acrylamide, acrylate ester, N-vinylpyrrolidones, or mixtures thereof.

17. The composition of claim 11 comprising a phosphonate component.

18. The composition of claim 17, wherein the phosphonate component comprises polyaminomethylenephosphonate (PAPEMP).

19. The composition of claim 11 comprising a stabilizer selected from the group consisting of choline chloride, a cationic compound, an anionic, or a zwitterionic compound.

20. (canceled)

21. A method of inhibiting deposit formation in produced water from a subterranean formation, the method comprising:
providing a composition comprising:
an unsaturated carboxylic acid present in the composition in about 60 weight % or less; and
an unsaturated sulfonic compound or sulfonic acid-based monomer bonded to an additional monomer comprising an anionic monomer, a non-ionic monomer, or a cationic monomer.

22.-34. (canceled)
